(19) United States
(12) Patent Application Publication
(10) Pub. No.: US 2009/0282617 A1
(43) Pub. Date: Nov. 19, 2009

(54) VALVE FOR A BLADDER

(76) Inventors: Flavia Abbate, Sydney (AU); Elisabeth Abbate, Sydney (AU)

Correspondence Address: DALINA LAW GROUP, P.C., 7910 IVANHOE AVE. #325, LA JOLLA, CA, 92037, US

(21) Appl. No.: 11/916,965

(22) PCT Filed: May 8, 2006
(86) PCT No.: PCT/AU2006/000599

§ 371 Date: Dec. 7, 2007

(30) Foreign Application Priority Data
May 6, 2005 (AU) 2005902289

(51) Int. Cl. A47C 20/00; F16K 1/00; B65D 30/00

(52) U.S. Cl. 5/630; 251/318; 383/3

(57) ABSTRACT

A valve for an inflatable bladder. The valve includes a body (4) that is adapted to be integrated into the wall (1) of the bladder. The body defines a bore (8) that allows fluid to pass from the interior of the bladder to the exterior or vice versa, and which is adapted to receive a plug (10). The plug is adapted to be moved between a first position within the bore in which the first end of the passageway is in fluid communication with the bore, thereby permitting the passage of fluid, and a second position within the bore in which it is not, thereby preventing the passage of fluid.

### FIELD OF THE INVENTION

The present invention relates to a valve for an inflatable bladder.

For the purposes of explanation, reference will be made to use of the present invention with respect to a physical therapy bolster. It would be understood by those of ordinary skill in the art however that the invention is not limited to use in physical therapy bolsters, its application could instead extend to use in any inflatable bladder.

### DESCRIPTION OF THE PRIOR ART

Known physical therapy bolsters (which are not admitted to form part of the common general knowledge) comprise a hollow bladder made from an elastic and pliable material that is open-able to the atmosphere through a manually operable valve. These valves comprise a valve member that extends through an aperture in the wall of the bladder, thereby plugging the aperture.

It has been found that there are a number of problems with valves of this type:

1. It is almost impossible to effect a controlled release of air from the bolster, as the valve must be completely removed from the aperture before it will permit air to escape;

2. If enough pressure is applied to the bolster these valves can be ejected from the aperture, allowing the bolster to deflate;

3. Because the valve must be completely removed in order to inflate or deflate the bolster, the valve can be lost; and

4. Once removed, the valve itself is a potential choking hazard for a small child.

### OBJECT OF THE INVENTION

It is therefore an object of the present invention to provide a valve for an inflatable bladder that substantially overcomes the problems associated with the valves of the prior art, or at least provides the public with a useful alternative.

Other objects and advantages of the present invention will become apparent from the following description, taken in connection with the accompanying drawings, wherein, by way of illustration and example, an embodiment of the present invention is disclosed.

### SUMMARY OF THE INVENTION

In one form of this invention although this may not necessarily be the only or indeed the broadest form of this there is proposed a valve for an inflatable bladder, the valve including a body adapted to be integrated into the wall of the bladder, said body defining a bore that allows fluid to pass from the interior of the bladder to the exterior or vice versa, and which is adapted to receive a plug, the plug having a fluid passageway passing there through, said passageway having a first end and a second end that is in fluid communication with the exterior of the bladder, wherein the plug is adapted to be moved between a first position within the bore in which the first end of the passageway is in fluid communication with the bore, thereby permitting the passage of fluid, and a second position within the bore in which it is not, thereby preventing the passage of fluid.

Preferably, the body of the valve defines a further, second bore that is in fluid communication with the interior of the bladder and the first bore.

Preferably, the passageway through the plug has a first end that is in fluid communication with the first bore, and a second end that is in fluid communication with the exterior of the bladder.

Preferably, there is a sealing member positioned in the first bore at a point between the first end of the passageway through the plug and the second bore, such that in use, when the plug is fully inserted into the first bore the seal is squeezed between a portion of the plug and the first bore in the body of the valve preventing the passage of fluid from the second bore to the first end of the passageway through the plug or vice versa.

Preferably, the fluid is either a gas or a liquid.

Preferably, the fluid is air.

Preferably, the bladder is made from an elastic and pliable material.

Preferably, the body of the valve is moulded into the wall of the bladder.

Preferably, the body and the plug are thread-ably engaged with one another.

Preferably, the body and the plug are made from a metallic material.

Preferably, the sealing member is an O-ring.

Preferably, the bladder is a physical therapy bolster.

Preferably, there is a layer of rubber or rubberised material between the metallic body of the valve, and the plastic material of the bladder.

### BRIEF DESCRIPTION OF THE DRAWINGS

For a better understanding of this invention it will now be described with respect to the preferred embodiment which shall be described herein with the assistance of drawings wherein;

FIG. 1 is a partial cross-section through a valve in the wall of an inflatable bladder, showing the plug in a closed position; and

FIG. 2 is a partial cross-section through the valve in FIG. 1, showing the plug in an open position.

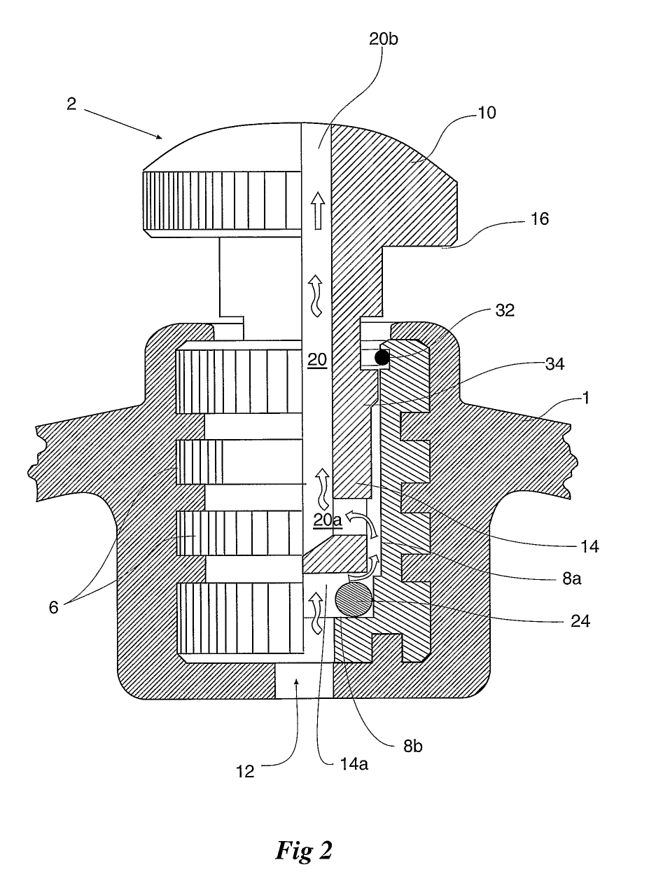

### DETAILED DESCRIPTION OF THE INVENTION

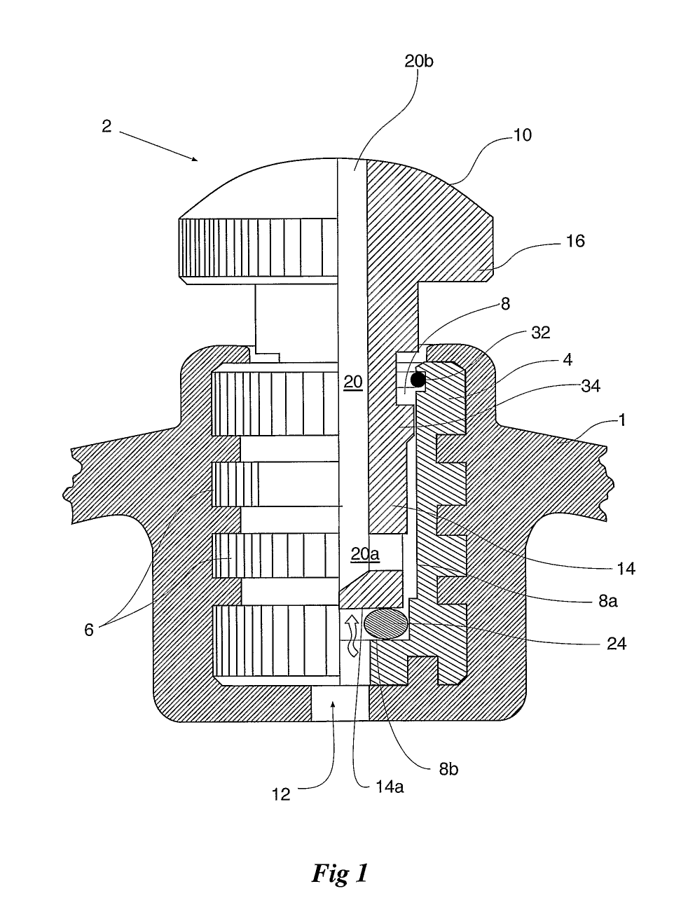

Referring now to FIG. 1, there is an inflatable bladder that is defined by a bladder wall 1. In this embodiment, the bladder is a physical therapy bolster made from an elastic and pliable plastics material. Integrated into the wall of the bolster by way of being moulded therein, is a manually operable valve 2, which facilitates inflation or deflation of the bolster with air as desired.

The valve 2 includes a body 4 that has been adapted to be moulded into the wall 1 of the bladder via the inclusion of a plurality of external ribs 6, which the elastic and pliable plastics material that the bolster is made from can mould around and into.

Because the valve 2 is made from a metallic material, it has been found that it is necessary to cover or coat the body 4 of the valve in a layer of rubber or rubberised material so that the plastic material from which the bladder is made will properly mould to the body of the valve.

The body of the valve 4 defines a first bore 8 that is adapted to receive a plug 10, and a second bore 12 that is in fluid communication with the interior of the bladder and the first bore 8. The diameter of the second bore 12 is less that that of the first bore 8. In the absence of the plug 10, fluid can pass through the first and second bores from the interior of the bladder to the exterior, or vice versa.

The plug 10 includes an elongate projecting portion 14 that is adapted for insertion into the first bore 8 in the body 4 of the valve 2, and a head portion 16 that is adapted to be manipulated by the hands of a user so that the valve can be operated.

The diameter of the plug 10 is locally reduced in a region toward the end 14a of the projecting portion 14, so that there is clearance between the first bore 8 and this portion of the plug 10.

Similarly, the diameter of the first bore 8 is locally increased at a point 8a, a distance from its bottom 8b.

There is a fluid passageway 20 passing through the plug 10, said passageway having a first end 20a that passes out through a sidewall of the projecting portion 14, and which is in fluid communication with the first bore 8, and a second end 20b that passes through the head 16 of the plug 10, and which is in fluid communication with the exterior of the bladder.

The plug 10 is adapted to be moved between a first position within the first bore 8 in which fluid can pass though the passageway 20 in the plug thereby facilitating inflation or deflation of the bolster, and at least a second position within the bore 8 in which no fluid can pass through the plug.

There is a sealing member, an O-ring 24, positioned in the bottom of the first bore 8 so that it lies between the first end 20a of the passageway 20 through the plug 10 and the second bore 12, such that in use, when the plug 10 is in the second position it is fully inserted into the first bore 8 and the O-ring 24 is squeezed between the end 14a of the plug and the bottom 8b of the first bore in the body of the valve, preventing the passage of fluid from the second bore 8 to the first end 20a of the passageway 20 through the plug or vice versa.

As the projecting portion 14 of the plug 10 is gradually withdrawn from the first bore 8, it reaches a point where the end 14a of the plug breaks contact with the O-ring 24, allowing fluid to pass between the O-ring 24 and the end of the plug 14a, through a passageway 30 created by the localised reduction and increase in the diameters of the projecting portion and the first bore respectively, through the passageway through the plug and out to atmosphere, or vice versa.

In use, the plug 10 is adapted to be moved between a first position within the bore 8 in which the first end 20a of the passageway is in fluid communication with the bore 8, thereby permitting the passage of fluid, and a second position within the bore 8 in which it is not, thereby preventing the passage of fluid.

A portion of the projecting portion 14 of the plug 10 can be threaded as to threadably engage with a similarly threaded portion in the first bore 8, so that the plug is inserted and withdrawn by rotating it within the bore in the same fashion as a bolt. This will allow a user to control the release of air from the bolster, and it will prevent the plug 10 from being ejected from the bore 8 in the event that a great deal of pressure is applied to the bolster.

Positioned at the opening to first bore 8 is a further O-ring or cir-clip 32 retained in an annular grove, which is adapted to catch a shoulder 34 on the projecting portion 14 of the plug 10 if the plug is inadvertently withdrawn too far. This prevents the plug from being removed completely, in which case it may potentially be lost and/or create a choking hazard for a small child.

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

1. A valve for an inflatable bladder, the valve including a body adapted to be integrated into the wall of the bladder, said body defining a bore that allows fluid to pass from the interior of the bladder to the exterior or vice versa, and which is adapted to receive a plug, the plug having a fluid passageway passing there through, said passageway having a first end and a second end that is in fluid communication with the exterior of the bladder, wherein the plug is adapted to be moved between a first position within the bore in which the first end of the passageway is in fluid communication with the bore, thereby permitting the passage of fluid, and a second position within the bore in which it is not, thereby preventing the passage of fluid.

2. The inflatable bladder of claim 1, wherein the body of the valve defines a further, second bore that is in fluid communication with the interior of the bladder and the first bore.

3. The inflatable bladder of claim 2, wherein the passageway through the plug has a first end that is in fluid communication with the first bore, and a second end that is in fluid communication with the exterior of the bladder.

4. The inflatable bladder of claim 3, wherein there is a sealing member positioned in the first bore at a point between the first end of the passageway through the plug and the second bore, such that in use, when the plug is fully inserted into the first bore the seal is squeezed between a portion of the plug and the first bore in the body of the valve preventing the passage of fluid from the second bore to the first end of the passageway through the plug or vice versa.

5. The inflatable bladder of claim 4, wherein the fluid is either a gas or a liquid.

6. The inflatable bladder of claim 5, wherein the fluid is air.

7. The inflatable bladder of claim 6, wherein the bladder is made from an elastic and pliable material.

8. The inflatable bladder of claim 7, wherein the body of the valve is moulded into the wall of the bladder.

9. The inflatable bladder of claim 8, wherein the body and the plug are threadably engaged with one another.

10. The inflatable bladder of claim 9, wherein the body and the plug are made from a metallic material.

11. The inflatable bladder of claim 10, wherein the sealing member is an O-ring.

12. The inflatable bladder of claim 11, wherein the bladder is a physical therapy bolster.

13. The inflatable bladder of claim 12, wherein there is a layer of rubber or rubberised material between the metallic body of the valve, and the plastic material of the bladder.

14. The inflatable bladder of claim 13, wherein there is a retaining member located within the body and adapted to engage at least a portion of an outer diameter of the plug so as to prevent removal of the plug from the body.
